(19) United States
(12) Patent Application Publication
(10) Pub. No.: US 2009/0012937 A1
(43) Pub. Date: Jan. 8, 2009

(54) APPARATUS, METHOD AND RECORDED MEDIUM FOR COLLECTING USER PREFERENCE INFORMATION BY USING TAG INFORMATION

(75) Inventors: Seunghwa LEE, Seoul (KR); Eunseok Lee, Gyeonggi-do (KR)

Correspondence Address: NEAL, GERBER, & EISENBERG, SUITE 2200, 2 NORTH LASALLE STREET, CHICAGO, IL, 60602, US

(73) Assignee: SUNGKYUNKWAN UNIVERSITY FOUNDATION FOR CORPORATE COLLABORATION, Gyeonggi-do (KR)

(21) Appl. No.: 12/040,714

(22) Filed: Feb. 29, 2008

(30) Foreign Application Priority Data
Jul. 3, 2007 (KR) 10-2007-0066658

(51) Int. Cl. G06F 7/06; G06F 17/30

(52) U.S. Cl. 707/3; 707/E17.014

(57) ABSTRACT

Disclosed are an apparatus, a method and a recorded medium for collecting user preference information by using tag information. In accordance with the present invention, the apparatus collecting user preference information by using tag information, the apparatus can include a tag search unit, searching at least one tag of an anchor tag, a form tag and a combination thereof which are included in a web document outputted to the apparatus; a tag information extracting unit, extracting tag information from the searched tag; a keyword detecting unit, detecting a keyword from the tag information; and a user preference information managing unit, collecting user preference information including a user profile generated by using the keyword. With the present invention, it is possible that user's preference can be quickly and accurately analyzed per user and customized information based on the analyzed preference can be provided to the user.

### CROSS-REFERENCE TO RELATED PATENT APPLICATIONS

This application claims the benefit of Korean Patent Application No. 10-2007-0066658, filed on Jul. 3, 2007, in the Korean Intellectual Property Office, the disclosure of which is incorporated herein in its entirety by reference.

### BACKGROUND OF THE INVENTION

1. Field of the Invention

The present invention relates to an apparatus, a method and a recorded medium for collecting user preference information, more specifically to the technology capable of collecting personalized and customized user preference information by using tag information.

2. Background Art

Today's prompt development of the information communication technologies has increased the use of Internet every day, and the amount of information on Internet has gradually swelled. However, very little information is actually useful for a user. This makes it very important to provide a user with the information that is customized to meet the user's demand.

Especially, it is necessarily required to suggest merchandise (or information) based on user preference information in order to activate commercial transaction and to improve the satisfaction and loyalty of the information provider (or web-shop) in an electronic commerce field. For this, one of the most important factors is to quickly and accurately analyze user preference.

Accordingly, various methods for analyzing user's interests have been studied. The most typical one of the methods provides customized information (e.g. web contents) based on the preference information which is evincively represented by a user when the user firstly visits a website. However, this method may be troublesome to the user, and it may be difficult to acquire the preference of the user who dynamically changes.

To solve the above problem, the methods of implicitly studying the preference through user's action have been developed. The well-known method analyzes all contents of the web document linked to the hyperlink selected by a user to study the preference of the user through the frequency of words used in the web document.

However, in accordance with the conventional art, it takes a lot of times to analyze all words included in connected web documents. The web documents also include unnecessary various types of information that may drop the accuracy of analysis of user's interests. Actually, lots of web documents repeatedly show movement buttons in websites and unnecessary information such as advertisement, company profile and copyright information. Since the web programming method maintaining a certain template and dynamically generating internal contents has been recently used, unnecessary contents are repeatedly included in the web documents much more.

Conventionally, the user preference information is separately managed by each web-server. If this user preference information can be unified and managed by user's apparatus and each server can require the unified and managed user preference information as long as necessary, it is possible that the shops providing similar merchandises usefully access information that a user are interested in at other shop websites.

### SUMMARY OF THE INVENTION

Accordingly, the present invention, which is contrived to solve the aforementioned problems, provides a method that can quickly and accurately analyze the preference per user individually by extracting a keyword from an anchor tag and/or a form tag.

The present invention provides a method of providing personalized search information by sending user preference information to a web-server.

Other problems that the present invention solves will become more apparent through the following description.

An aspect of the present invention features an apparatus collecting user preference information by using tag information. The apparatus can include a tag search unit, searching at least one tag of an anchor tag, a form tag and a combination thereof which are included in a web document outputted to the apparatus; a tag information extracting unit, extracting tag information from the searched tag; a keyword detecting unit, detecting a keyword from the tag information; and a user preference information managing unit, collecting user preference information including a user profile generated by using the keyword.

Also, the tag information can include the anchor tag and the form tag, and the anchor tag comprises an anchor text and a uniform resource locator (URL) connected to the anchor text, and the form tag comprises a query word and an URL connected to the query word.

The apparatus can further include a mapping table creating unit, creating a mapping table in which all parts or some parts of tag information included in the web document are written.

The keyword detecting unit can exclude a stop word from words included in the tag information to detect the keyword.

The user preference information managing unit can include a weight computing unit, computing a weight per the detected keyword; and a user profile unit, creating a user profile including the keyword and points to which a weight of the keyword is applied.

The user preference information managing unit can further include a user monitoring unit monitoring a movement between web documents.

Here, the weight can be added according to an increased frequency in use of the keyword.

Also, the weight can be subtracted for the keyword that is not selected by a user although the keyword is included in the mapping table or the user profile.

The keywords included in the user profile can be ranked according to a point in accordance with the weight.

The keywords included in the user profile are limited to the N^{th} ranking, N being a natural number.

The apparatus can further include an input unit, receiving a command signal for a web document desired to be displayed from a user; and an output unit, displaying the web document according to the inputted command signal.

The apparatus can further include a storage unit, storing the tag information, a mapping table and the user profile.

Another aspect of the present invention features a method of collecting user preference information by using tag information by an apparatus. The method can include analyzing a hypertext makeup language (HTML) source of a web document outputted to the apparatus and searching at least one tag of an anchor tag, a form tag and a combination thereof which are included in the web document outputted; extracting tag information from the searched tag; detecting a keyword from the tag information; and collecting user preference information including a user profile generated by using the keyword.

Also, the tag information can include the anchor tag and the form tag, and the anchor tag can include an anchor text and a uniform resource locator (URL) connected to the anchor text, and the form tag comprises a query word and an URL connected to the query word.

The method can further include creating a mapping table in which all parts or some parts of tag information of the web document are written.

The method can further include allowing the apparatus to output a next web document; acquiring an URL of the next web document; determining whether the URL of the next web document is connected to the anchor tag or the form tag; and extracting an anchor text or a query word corresponding to the URL of the next document if the URL is an URL included in the mapping table.

The step of detecting the keyword excludes a stop word from words included in the tag information to detect the keyword.

The step of collecting the user preference information can include computing a weight per the detected keyword; and creating a user profile including the keyword and points to which a weight of the keyword is applied.

The step of collecting the user preference information can further include monitoring a movement between web documents.

Here, the method can further include asking a web server for search information related to a query word inputted from a user; allowing the web server to require the user preference information; and providing the user preference information to the web server.

The method can further include receiving search information selected based on the user preference information from the web server.

Also, the user preference information can be a user profile created in the apparatus.

The weight can be added according to an increased frequency in use of the keyword.

The weight can be subtracted for the keyword that is not selected by a user although the keyword is included in the mapping table or the user profile.

The keyword can be ranked according to a point in accordance with the weight.

The keywords included in the user profile can be limited to the Nth ranking, N being a natural number.

The method can further include receiving a command signal for a web document desired to be displayed from a user; and displaying the web document according to the inputted command signal.

The method can further include storing the tag information, the mapping table and the user profile.

Another aspect of the present invention features a recorded medium tangibly embodying a program of instructions executable by an apparatus to collect user preference information by using tag information, the recorded medium being readable by the apparatus, the program comprising: analyzing a hypertext makeup language (HTML) source of a web document outputted to the apparatus and searching at least one tag of an anchor tag, a form tag and a combination thereof which are included in the web document; extracting tag information from the searched tag; detecting a keyword from the tag information; and collecting user preference information including a user profile generated by using the keyword.

### BRIEF DESCRIPTION OF THE DRAWINGS

These and other features, aspects and advantages of the present invention will become better understood with regard to the following description, appended Claims and accompanying drawings where:

FIG. 1 is a simplified diagram illustrating the general system for providing user preference information in accordance with an embodiment of the present invention;

FIG. 2 illustrates the structure of an apparatus capable of collecting user preference information in accordance with an embodiment of the present invention;

FIG. 3 illustrates a webpage including a hyperlink in accordance with an embodiment of the present invention;

FIG. 4 illustrates the HTML source of the webpage of FIG. 3;

FIG. 5 is a mapping table created by extracting anchor tag information from the HTML source of FIG. 4;

FIG. 6 illustrates a webpage including an address bar in which form tag information is displayed in accordance with an embodiment of the present invention;

FIG. 7 illustrates the structure of a user preference information managing unit in accordance with an embodiment of the present invention;

FIG. 8 is a user profile showing the rankings of keywords determined by using a weight computing method in accordance with an embodiment of the present invention;

FIG. 9 is a flowchart illustrating the method of providing user preference information by an apparatus in accordance with an embodiment of the present invention; and

FIG. 10 is a flowchart illustrating the method of allowing an apparatus to provide user preference information to a web server.

### DESCRIPTION OF THE EMBODIMENTS

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the spirit and scope of the present invention.

Terms such as “first” and “second” can be used in describing various elements, but the above elements shall not be restricted to the above terms. The above terms are used only to distinguish one element from the other. For instance, the first element can be named the second element, and vice versa, without departing the scope of claims of the present invention. The term “and/or” shall include the combination of a plurality of listed items or any of the plurality of listed items.

When one element is described as being “connected” or “accessed” to another element, it shall be construed as being connected or accessed to the other element directly but also as possibly having another element in between. On the other hand, if one element is described as being “directly connected” or “directly accessed” to another element, it shall be construed that there is no other element in between.

The terms used in the description are intended to describe certain embodiments only, and shall by no means restrict the present invention. Unless clearly used otherwise, expressions in the singular number include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

Unless otherwise defined, all terms, including technical terms and scientific terms, used herein have the same meaning as how they are generally understood by those of ordinary skill in the art to which the invention pertains. Any term that is defined in a general dictionary shall be construed to have the same meaning in the context of the relevant art, and, unless otherwise defined explicitly, shall not be interpreted to have an idealistic or excessively formalistic meaning.

Hereinafter, preferred embodiments will be described in detail with reference to the accompanying drawings. Identical or corresponding elements will be given the same reference numerals, regardless of the figure number, and any redundant description of the identical or corresponding elements will not be repeated.

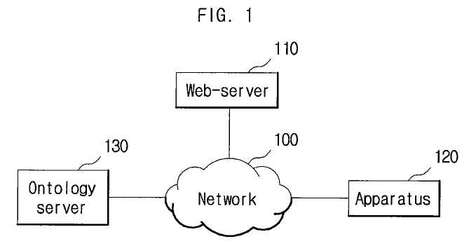

FIG. 1 is a simplified diagram illustrating the general system for providing user preference information in accordance with an embodiment of the present invention.

Referring to FIG. 1, the user preference information providing system can be configured to include a network 100, an apparatus 110, a web-server 120 and an ontology server 130.

The network 100, which is a wire or wireless communication network, can connect the apparatus 110, the web-server 120 and the ontology server 130. Communicating data between the apparatus 110 and each server 120 and 130 can be performed by a predetermined communication protocol. It is not necessary that the network 100 connecting each server 120 and 130 and the apparatus 110 is one network.

The network 100 can be also configured in a form of local area network (LAN) or wide area network (WAN) by an asymmetric digital subscriber line (ADSL), a very high-data rate digital subscriber line (VDSL), a wireless-fidelity (Wi-Fi), a wireless broadband (WIBRO) and a high speed downlink packet access (HSDPA) and a virtual private network (VPN).

The web-server 120, which is the server capable of providing a web service, can provide the apparatus 110 with web documents such as webpages, some parts of the webpages and video. Here, the “document” can refer to the data having formats, capable of being indexed and searched by a search engine, such as webpages, video, multimedia files, text files and PDF files, for example. The term “document” shall by no means restrict the scope of the present invention.

The apparatus 110 can be an information communication terminal having the same function as the network 100 such as desktop computers, PDA and mobile phones. Alternatively, the apparatus 110 can be realized as an electronic device capable of accessing the web-server 120 through the network 100 or as a kind of server capable of servicing contents to users, for example.

In the embodiment of the present invention, the apparatus 110 can access the web-server 120 through the wire or wireless network 100 to be provided with the web document or can receive the service of deleting stop words from the ontology server 130.

The ontology server 130 can analyze the meaning of words detected from tag information included in the web document and delete stop words. The ontology can be considered as a kind of dictionary including words and their relations and can hierarchically represent words related to a certain domain.

Here, the stop words can refer to the postposition in Korean or the definite/indefinite word or the preposition in English, which are frequently used but are not independently used. For example, [symbol] ” or “ [symbol] ” in Korean or “a/an” or “the” in English can be classified as the stop words.

In accordance with another embodiment of the present invention, the apparatus 110 can delete the stop words. In particular, the apparatus 110 can filter necessary keywords by deleting unnecessary words from the tag information by use of the information (e.g. a stop word list) provided from the ontology server 130.

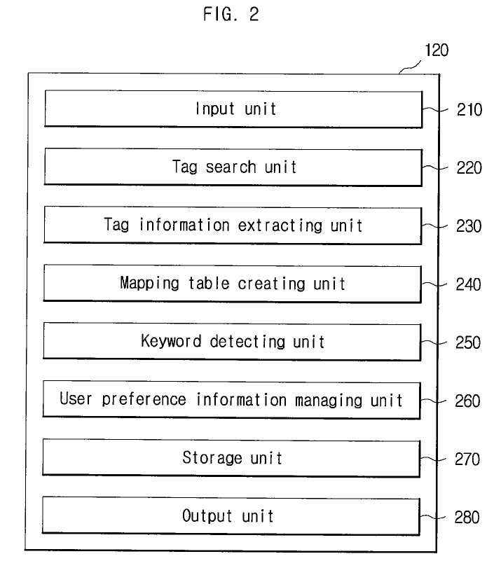

FIG. 2 illustrates the structure of an apparatus capable of collecting user preference information in accordance with an embodiment of the present invention.

Referring to FIG. 2, in accordance with the embodiment of the present invention, the apparatus 110 can include an input unit 210, a tag search unit 220, a tag information extracting unit 230, a mapping table creating unit 240, a keyword detecting unit 250, a user preference information managing unit 260, a storage unit 270 and a output unit 280.

The input unit 210 can receive a signal for performing the information search or a signal selected through user's input of query words or user's mouse-clicking of hyperlink, for example. Herein, the input unit 210 can employ a keyboard, a button, a mouse or other input means.

After the apparatus 110 receives contents (i.e. web document such as webpages, a part of the webpages and video) from the web server 120 and outputting the received contents, the tag search unit 220 can search the overall part or some parts of an anchor tag and/or a form tag included in the outputted document. The tag search can be performed by analyzing the hypertext markup languish (HTML) source of web documents by use of a source analyzer mounted inside the apparatus 110.

Here, the anchor tag can refer to the tag that generates a hyperlink among the HTML for producing hypertext. The hyperlink can be realized as graphic icons or text lines. A user can move to a web document connected to the hyperlink by clicking the mouse button. A web browser can mostly convert to the webpage designated as hyperlinks and display the webpage. Also, the hyperlink can download data and display a video.

The emphasized object can be called as an ‘anchor.’ The anchor can form a hypertext link. In the HTML, the anchor can declare sentences, images and all other information objects.

The form tag can receive data needed for web programming, such as ASP, PSP, and JSP, and transfer the data to the server. An input window, a password window and a check box can be created by using the form tag.

The tag information extracting unit 230 can extract tag information from the anchor tag and/or the form tag searched by the tag search unit 220. Here, the “tag information” can be distinguished into anchor tag information and form tag information.

The anchor tag information can include a uniform resource locator (URL) connected to the tag as information included in the anchor tag generating hyperlinks and an anchor text which is a text string of hypertext.

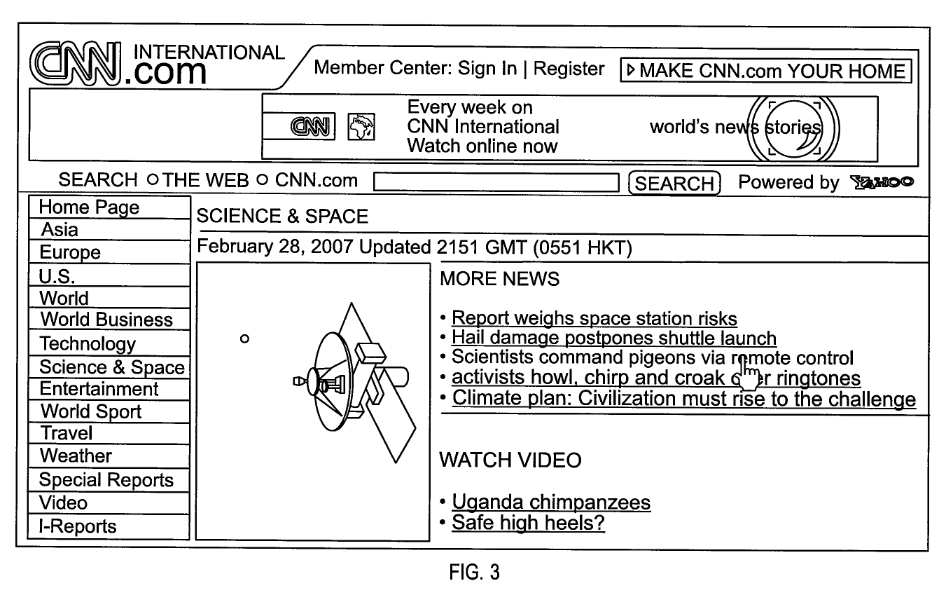

For example, extracting anchor tag information can be performed by firstly extracting a web document source from the pertinent tag and secondly extracting an URL, a text string of hypertext and a queried text string from the extracted web document. The extraction of the anchor tag information and the use of the extracted anchor tag information will be described later in detail with reference to FIG. 3 through FIG. 5.

The form tag can include query information such as a text string queried to a command processing unit (not shown) using the web programming language and an URL structure processing user's queries.

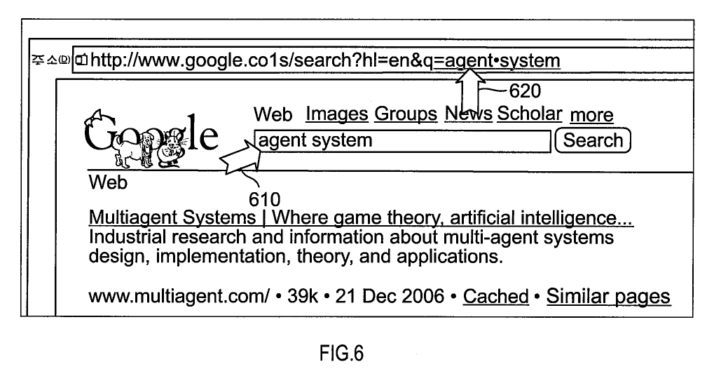

Accordingly, the form tag can extract an ‘action’ which is the attribute of determining the destination to which the received data is transmitted, a ‘method’ which is the attribute of determining the transferring method when the data is transferred to the destination determined by the action and an URL structure processing user's query word by additionally searching whether there is an input tag. This will be described in detail with reference to FIG. 6.

Here, the query word can be text information such as a text string that a user queries to the command processing unit (not shown) by inputting a text into the input unit 210 of the apparatus 110 by use of a keyboard. The command processing unit can be realized by using a web programming language.

The extracted tag information can be used to create a mapping table, and the mapping table can be referred to for making a user profile later.

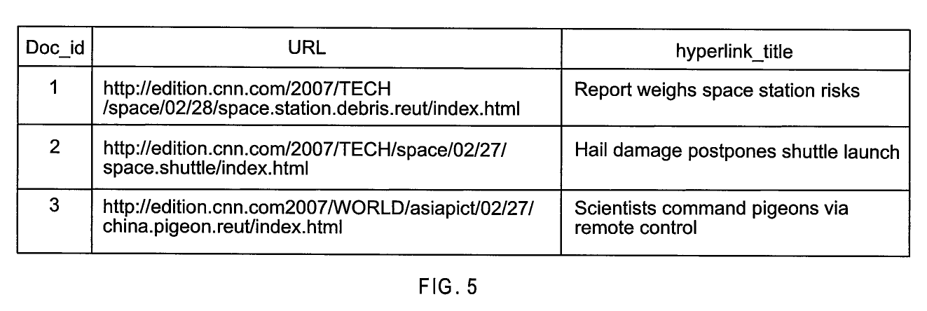

The mapping table creating unit 240 can create a mapping table by using the anchor tag information extracted from the tag information extracting unit 230. The mapping table can be created in various forms. The example of the mapping table created by classifying the URL of the anchor tag of FIG. 5 and an anchor text which is a hyperlink title. This will be described in detail later.

The keyword detecting unit 250 can detect a keyword from the anchor tag information and/or the form tag information extracted by the tag information extracting unit 230 and store the extracted keyword. For example, the keyword detecting unit 250 can transmit tag information and receive the detected keyword from the ontology server 130 or delete stop words by itself by using the stop word dictionary of the ontology server 130.

For example, if the anchor tag is <a href=“http://www.skku.ac.kr“> Sungkyunkwan University </a>, the words “Sungkyunkwan University” can be extracted as the keyword.

Also, in the case of the anchor text, the words “Sungkyunkwan University” can be considered as having no other stop words and can be extracted as it is as the keyword.

The user preference information managing unit 260 can collect and upgrade user preference information by comparing the URL of a next web document to which the apparatus 110 moved with the mapping table. The next web document, to which the apparatus 110 can refer to the document that is outputted later by the apparatus 110.

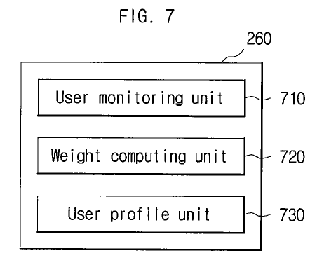

Here, the user preference information can be a user profile made in the apparatus 110. Also, at least one of the tag information collected in the apparatus 110, the mapping table and its combination can be provided as the user preference information to the web-server 120. Through this, the web-server 120 can make the user profile. The user preference information managing unit 260 will be described in detail with reference to FIG. 7.

The storage unit 270, which is a medium capable of all kinds of data by the process performed by the apparatus 110, can include a database. For example, the storage unit 270 can store tag information. The tag information can be used to generate a user profile applied with user preference information extracted by the user preference information managing unit 260. This generated user profile can be also stored in the storage unit 270.

The output unit 280 can visually or acoustically provide data needed to show a searched result. The output unit 280 can include a display unit (not shown) such as a liquid crystal display (LCD) and/or a sound unit (not shown) such as a speaker.

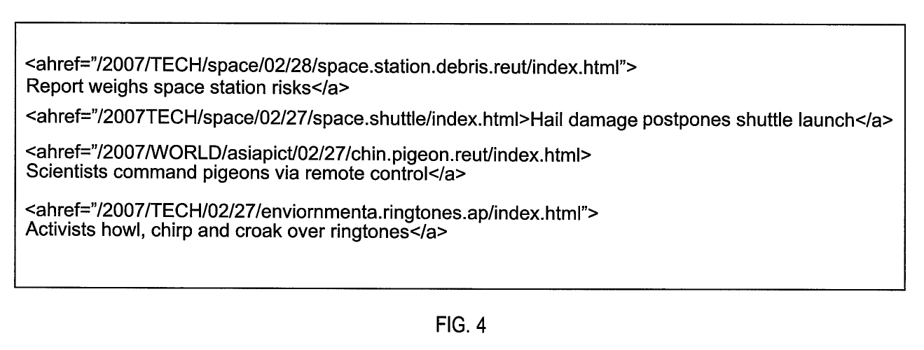

FIG. 3 illustrates a webpage including a hyperlink in accordance with an embodiment of the present invention, and FIG. 4 illustrates the HTML source of the webpage of FIG. 3. FIG. 5 is a mapping table created by extracting anchor tag information from the HTML source of FIG. 4.

Referring to FIG. 3, the web document outputted in the apparatus 110 can be configured to include at least one hyperlink. As shown in FIG. 3, the hyperlinked text information can be the text information corresponding to the title of the web document accessed through the hyperlink. The hyperlink included in the web document, as illustrated in FIG. 4, can be included in a web document source and be displayed. The anchor tag included in the web document source can include the anchor text that is set as hyperlink title, representing the website having the following URL and the pertinent address.
<a href=“URL”>Anchor text </a>

As an example of the sources shown in FIG. 4, in case that the anchor tag is <a href=“/2007/WORLD/asiapct/02/27/china_pigeon.reut/index.html”> Scientists command pigeons via remote control </a>, the hyperlink having the title of “Scientists command pigeons via remote control” can be generated. If a user clicks the hyperlink by using a mouse, the website corresponding to “/2007/WORLD/asiapct/02/27/china_pigeon.reut/index.html” can be connected.

FIG. 5 illustrates the mapping table created by extracting the tag information such as the anchor text corresponding to the URL and the hyperlink title connected to the URL and dividing the tag information per item.

Referring to FIG. 5, the mapping table can be set to be divided into the URL and the anchor text corresponding to the hyperlink title. Then, the words of the anchor text can also undergo the operation of extracting only keywords by deleting stop words.

In other words, the apparatus 110 can write the tag information of overall part or some parts of the tags included in the outputted web document in the mapping table and recognize whether the URL of a next web document to which the apparatus 110 moved is included in the mapping table. Accordingly, if the URL of the next web document to which the apparatus 110 moved is included in the mapping table, the apparatus 110 can recognize the anchor text connected to the URL.

As such, the mapping table can be needed to identify the hyperlink of the web document that a user selects and moves to and to compute the weight of a word included in a user profile, and the load of the storage unit 270 can be reduced by temporally storing the hyperlink.

In accordance with another embodiment of the present invention, the keywords of the anchor text can be firstly extracted. Accordingly, the anchor text can consist of the keywords. In other words, the operation of detecting the keywords can be performed at any time after or before the mapping table is created.

Also, in accordance with another embodiment of the present invention, the mapping table can include form tag information as well as the anchor tag information. In other words, the apparatus 1 10 can write the tag information of the overall part or some parts of the tags included in the web document outputted to the apparatus 110 in the mapping table.

FIG. 6 illustrates a webpage including an address bar in which form tag information is displayed in accordance with an embodiment of the present invention.

There can be ‘action’ and ‘method’ as the attributes of the form tag. The ‘action’ can determine a destination to which the data received from the form tag is transmitted by designating the name of a file transferred from the form tag, and the ‘method’ can determine the transferring method when the data is transferred to the destination determined by the ‘action’. For example, in the case of <form action=“abc.php” method=“get/post”>, the data in the form tag can be transferred to the abc.php by the method of the get/post.

The get/post, which is the tag designating the transferring method of data, can be considered as a method value. In accordance to the get method, an inputted parameter value can be seen in the address bar of a web browser. Unlike the get method, in accordance to the post method, a parameter value may not be seen in the address bar of the web browser.

FIG. 6 illustrates an example of the form tag, the ‘method’ of which is the get method. If the apparatus 110 inputs “agent system” as the query word into an input window 610 in order to search desired information in the search engine, the query word can be added to the back of the URL, to desired to be transferred, along with ‘?’ and can be transferred. Here, the window into which the query word is inputted can correspond to the input tag used in the form tag.

If the URL of the next web document to which a user moved is an address connected to the form tag, the apparatus 110 can extract user's query word added to the pertinent address from the address bar of the web document. Referring to FIG. 6, the apparatus 110 can extract the query words “agent” and “system” from the added word “agent*system” 620. The words extracted later can be determined whether to be keyword. If it is determined that the later-extracted word is the keyword, the word can be stored in the user profile.

In the meantime, in case that the apparatus 110 can transmit the query word by the post method, which is not shown, the query word can be added to the body of data and be transferred. Since the data to be transferred is inside, the data can be unseen from an outside.

Accordingly, in accordance with an embodiment of the present invention, in case that the query word is transmitted by the post method, the apparatus 110 is unable to immediately extract the query word. In this case, the apparatus 110, however, can ask the query word to the web server 120 and receive a corresponding response to recognize the query word.

Meanwhile, if a plurality of form tags is included in the web document displayed on the liquid crystal screen of the apparatus 110, the mapping table of the form tag information can be created like the anchor tag.

In other words, the query word and URL information connected to the query word as well as the anchor tag can be stored in order to recognize which form tag of the plurality of form tags the apparatus moves through.

FIG. 7 illustrates the structure of a user preference information managing unit in accordance with an embodiment of the present invention.

Referring to FIG. 7, the user preference information managing unit 260 can be configured to include a user monitoring unit 710, a weight computing unit 720 and a user profile unit 730.

The user monitoring unit 710 can monitor the movement between web documents in the apparatus 110. Also, the user monitoring unit 710 can identify URL information of a next webpage to which a user moved and check whether there are the same URLs in the mapping table and whether the URLs are connected to the analyzed form tag.

In particular, if the URL of the next webpage to be moved is included in the mapping table, the text stings connected to the URL can be collected. Also, the URL is connected to the form tag, user query texts included in a pertinent address can be extracted.

Accordingly, the apparatus 110 can accurately recognize tag information that a user selects by allowing the user monitoring unit 710 to monitor user selection.

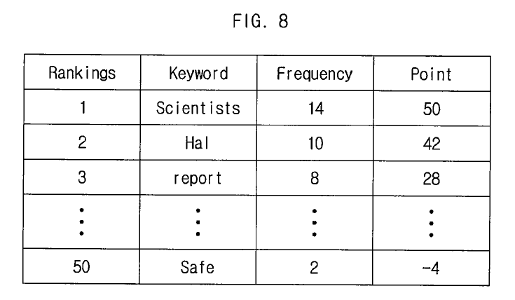

The weight computing unit 720 can give points to keywords extracted from the tag information according to a standard and compute weights. At this time, the weight computing method can be realized in various ways. This will be described later in detail with reference to FIG. 8.

The user profile unit 730 can perform the generation, update and management of the user preference information per apparatus 110 by using the keywords detected by the keyword detecting unit 250. Here, the user profile can consist of words including keywords and combinations of the weights of the words.

The user profile can be created by computing the weights, given per word, and the ranking, applied with the weights, per item. At this time, since the weight can be set to be changed by applying the real-time operation of the apparatus 110, the user profile ranking can be also adjusted in real-time according to the re-applied weight.

The user profile unit 730 can designate the number of words included in the user profile as a default value as necessary or allow the number of words to be set by a user.

As described above, in case that the user profile ranking is re-adjusted in real-time, if the number of the words is limited to n, n words can be included in the user profile unit 730 in the descending order, for example. Here, n is a natural number.

In this case, the words, the user profile ranking of which is lower than n^{th}, can be deleted, and the words, the user profile ranking of which is the same as or higher than n^{th}, can be included in the user profile.

At this time, the words deleted in the user profile may not be deleted in the storage unit 270 and can be still used to compute the frequency in use of words. For example, in the case of 10 words that is managed in the user profile, since the frequency in use of the words which are not in the 10^{th} ranking has been continuously counted, if the words are included in the 10^{th} ranking later, the words can be included in the user profile.

FIG. 8 is a user profile showing the rankings of keywords determined by using a weight computing method in accordance with an embodiment of the present invention.

The present invention aims to generate a personalized user profile per apparatus 110 and to provide preference information per user based on the generated user profile. In particular, if user interest levels are numerically expressed by giving weights to each word extracted from the tag information by the apparatus 110 and their rankings are indexed according to the numerically expressed user interest levels, more accurate user preference information can be provided.

Referring to FIG. 8, the user profile can consist of the combinations of points computed by using the words extracted from the tag information and their weights. Giving weights to each word and ranking the words can be performed in various ways by a user.

For example, the high frequency in use of a word can mean that a user clicks the word many times by using a mouse. As a result, it can be said that the word has high interest of the user and is more useful. Reversely, the low frequency in use of the word can mean that the word has low interest of the user and is less useful. Accordingly, the word having the high frequency can have a higher point and ranking than the words having the low frequency by giving weights to the words having the high frequency.

Also, some words of the hyperlinks may be not clicked by a user although since the words are tag information that was included in the web document outputted to the apparatus 110, the words are included in the mapping table. At this time, the apparatus 110 can reduce the weights of the words considering that the user recognizes the words but does not select the words.

For example, if the word used one time in the user profile is assumed to be given to zero point, the apparatus 110 can add +K points into the word every time when the frequency in use of the word is increased by one time. Reversely, the apparatus 110 can add −L points into the words, which are not included in a hyperlink title connected to the URL selected and moved by a user although since the words are written in the web document displayed to the apparatus 110, the words are included in the mapping table.

In this case, the point of one word can be computed by the following formula.

Point=(a×K)−(b×L)

Here, ‘a’ refers to how many a certain word is clicked, and ‘b’ refers to how many a certain word is not clicked although the certain word is included in the mapping table. Also, the words selected by a user can have more weights by allowing the K to be the same as or larger than the L.

In accordance with another embodiment of the present invention, it is considered that the increased frequency in use of a word selected by a user indicates very large interest levels of the user. Accordingly, the weights can be computed to allow the points to be exponentially increased according to the frequency.

Point=K^{a}−(b×L)

Here, ‘a’ and ‘b’ can be the same as described above.

In accordance with another embodiment of the present invention, the apparatus 110 can dynamically apply the change of user's preference by reducing the weight of the words included in the URL which is included in the user profile and the mapping table but is not selected by the user.

In accordance with another embodiment of the present invention, the points and rankings can be computed in proportion to the frequency in use of the words.

Also, referring to FIG. 8, the words having the 1^{st} through N^{th} rankings, N being a natural number, can be included in the user profile. In other words, the number of the words included in the user profile can be determined as necessary by a user or a developer, and the words having the ranking that is lower than a threshold value can be deleted in the user profile.

The present invention can accurately provide a recent user interest field by analyzing user preference information in real-time and applying the analyzed information to re-adjust the rankings. Also, the road of the storage unit 270 can be reduced by limiting the number of the words stored in the user profile.

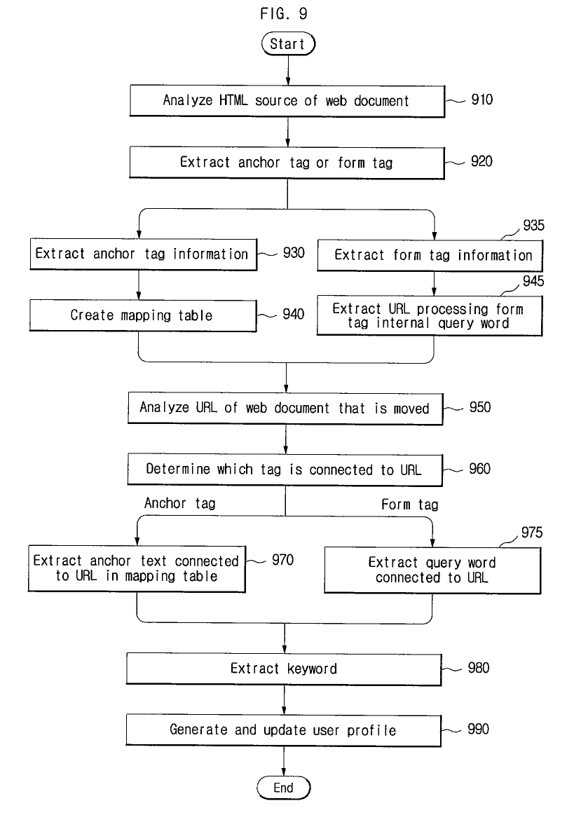

FIG. 9 is a flowchart illustrating the method of providing user preference information by an apparatus in accordance with an embodiment of the present invention.

In a step represented by 910, the apparatus 110 can analyze the HTML source of a web document outputted to the output unit 280 of the apparatus 110. In a step presented by 920, the apparatus 110 can search an anchor tag and/or a form tag among the HTML source analyzed in the step represented by 910 in order to extract the searched tag.

Further, the apparatus 110 can recognize whether the extracted tag is the anchor tag or the form tag in the step represented by 920. If the extracted tag is the anchor tag, the apparatus 110 can extract the anchor tag information in a step represented by 930.

The anchor tag information can include an URL connected to the anchor tag and/or an anchor text which is a hypertext string. Then, the apparatus 110 can create a mapping table by using the extracted URL and anchor text in a step represented by 940.

If the tag extracted in the step represented by 920 is the form tag, the apparatus 110 can extract form tag information in a step represented by 935. Then, the apparatus 110 can extract an URL processing a form tag internal query word in a step represented by 945.

In a step represented by 950, the apparatus 110 can analyze the URL of a next web document that is moved. Then, the apparatus 110 can determine whether the URL of the moved web document is connected to the anchor tag or the form tag in a step represented by 960.

If it is determined that the URL is connected to the anchor tag, in a step represented by 970, the apparatus 110 can compare the URL with the URL included in the mapping table. If the URL is the same as the URL included in the mapping table, the apparatus 110 can extract and analyze the anchor text which is the hyperlink title connected to the pertinent URL.

As the result determined in the step represented by 960, if the URL of the moved web document is connected to the form tag, the apparatus 110 can extract a query word connected to the pertinent URL in a step represented by 975.

In particular, if the query word is transmitted by the ‘get’ method, the apparatus 110 can extract the query word displayed in the address bar of a liquid crystal screen by itself. However, if the query word is transmitted by the ‘post’ method, the method of providing user preference information can further include requiring information related to the query word connected to the URL of the web document moved from the web server 120 and receiving the corresponding response.

Then, the apparatus 110 can delete unnecessary words in the extracted text information by using a stop word dictionary of the ontology server 130 in a step represented by 980. Accordingly, the keywords can be extracted from the anchor tag information.

In a step represented by 990, the apparatus 110 can generate a user profile by using the extracted keywords and update the generated user profile information. Here, the extracted keywords can be written along with the rankings applied with the frequency in use and/or the weights.

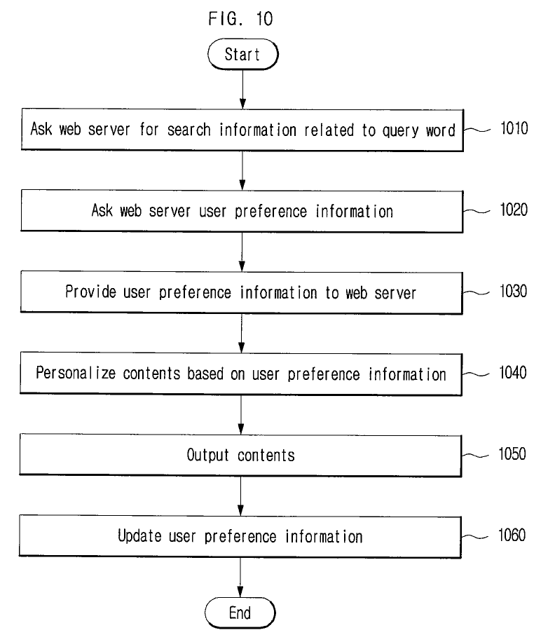

FIG. 10 is a flowchart illustrating the method of allowing an apparatus to provide user preference information to a web server.

Referring to FIG. 10, in a step represented by 1010, the apparatus 110 can ask the web server 120 for search information related to the query word required from a user. Then, in a step represented by 1020, the web server 120 can ask the apparatus 110 for user preference information before providing the contents related to the search-required query word.

If there is user preference information in the apparatus 110, the apparatus 110 can transmit the built-in user preference information to the web server in a step represented by 1030. Here, the user preference information that the apparatus 110 is about to transmit can be a user profile.

In a step represented by 1040, the web server 120 can personalize contents to be provided based on the user preference information transmitted by the apparatus 110 and transmit the personalized contents to the apparatus 1 10. Here, personalizing the contents can be performed by determining the rankings of a lot of contents related to the search-required query word to correspond to the user preference information in order to firstly provide the information in which users are most interested to each of the users. For example, when the result searched corresponding to the search keywords inputted by a user is provided to the apparatus 110, the items of the searched result corresponding to the user preference information can be firstly displayed.

In a step represented by 1050, the apparatus 110 can output contents transmitted from the web server 120 on a liquid crystal screen. Then, the user preference information managing unit 260 of the apparatus 110 can update the user preference information by monitoring user's action in a step represented by 1060. For example, as described above, the user profile can be updated in real-time by applying the movement of user's web documents.

If there is no user preference information in the apparatus 110, the web server 120 can provide typical contents related to the search-required query word to the apparatus 110.

As described above, the method of the present invention embodying a program can be stored in a recorded medium, being readable by a computer, such as a CD-ROM, an RAM, an ROM, a hard disk and a magneto-optical disk.

The present invention is not limited to the embodiment, and it is naturally possible that a large number of permutations are performed by any person of ordinary skill in the art within the scope of the present invention.

Hitherto, although some embodiments of the present invention have been shown and described for the above-described objects, it will be appreciated by any person of ordinary skill in the art that a large number of modifications, permutations and additions are possible within the principles and spirit of the invention, the scope of which shall be defined by the appended claims and their equivalent.

What is claimed is:

1. An apparatus collecting user preference information by using tag information, the apparatus comprising:
a tag search unit, searching at least one tag of an anchor tag, a form tag and a combination thereof which are included in a web document outputted to the apparatus;
a tag information extracting unit, extracting tag information from the searched tag;
a keyword detecting unit, detecting a keyword from the tag information; and
a user preference information managing unit, collecting user preference information including a user profile generated by using the keyword.

2. The apparatus of claim 1, wherein the tag information comprises the anchor tag and the form tag, and
the anchor tag comprises an anchor text and a uniform resource locator (URL) connected to the anchor text, and the form tag comprises a query word and an URL connected to the query word.

3. The apparatus of claim 1, further comprising a mapping table creating unit, creating a mapping table in which all parts or some parts of tag information included in the web document are written.

4. The apparatus of claim 1, wherein the keyword detecting unit excludes a stop word from words included in the tag information to detect the keyword.

5. The apparatus of claim 1, wherein the user preference information managing unit comprises:
a weight computing unit, computing a weight per the detected keyword; and
a user profile unit, creating a user profile including the keyword and points to which a weight of the keyword is applied.

6. The apparatus of claim 5, wherein the user preference information managing unit further comprises a user monitoring unit monitoring a movement between web documents.

7. The apparatus of claim 5, wherein the weight is added according to an increased frequency in use of the keyword.

8. The apparatus of claim 5, wherein the weight is subtracted for the keyword that is not selected by a user although the keyword is included in the mapping table or the user profile.

9. The apparatus of claim 5, wherein keywords included in the user profile is ranked according to a point in accordance with the weight.

10. The apparatus of claim 9, wherein keywords included in the user profile are limited to the N^{th} ranking, N being a natural number.

11. The apparatus of claim 1, further comprising: an input unit, receiving a command signal for a web document desired to be displayed from a user; and
an output unit, displaying the web document according to the inputted command signal.

12. The apparatus of claim 1, further comprising: a storage unit, storing the tag information, a mapping table and the user profile.

13. A method of collecting user preference information by using tag information by an apparatus, the method comprising:
analyzing a hypertext makeup language (HTML) source of a web document outputted to the apparatus and searching at least one tag of an anchor tag, a form tag and a combination thereof which are included in the web document outputted;
extracting tag information from the searched tag;
detecting a keyword from the tag information; and
collecting user preference information including a user profile generated by using the keyword.

14. The method of claim 13, wherein the tag information comprises:
the anchor tag and the form tag, and
the anchor tag comprises an anchor text and a uniform resource locator (URL) connected to the anchor text, and the form tag comprises a query word and an URL connected to the query word.

15. The method of claim 13, further comprising creating a mapping table in which all parts or some parts of tag information of the web document are written.

16. The method of claim 15, further comprising:
allowing the apparatus to output a next web document;
acquiring an URL of the next web document;
determining whether the URL of the next web document is connected to the anchor tag or the form tag; and
extracting an anchor text or a query word corresponding to the URL of the next document if the URL is an URL included in the mapping table.

17. The method of claim 13, wherein the step of detecting the keyword excludes a stop word from words included in the tag information to detect the keyword.

18. The method of claim 13, wherein the step of collecting the user preference information comprises:
computing a weight per the detected keyword; and
creating a user profile including the keyword and points to which a weight of the keyword is applied.

19. The method of claim 18, wherein the step of collecting the user preference information further comprises monitoring a movement between web documents.

20. The method of claim 18, further comprising:
asking a web server for search information related to a query word inputted from a user;
allowing the web server to require the user preference information; and
providing the user preference information to the web server.

21. The method of claim 20, further comprising receiving search information selected based on the user preference information from the web server.

22. The method of claim 20, wherein the user preference information is a user profile created in the apparatus.

23. The method of claim 18, wherein the weight is added according to an increased frequency in use of the keyword.

24. The method of claim 18, wherein the weight is subtracted for the keyword that is not selected by a user although the keyword is included in the mapping table or the user profile.

25. The method of claim 18, wherein the keyword is ranked according to a point in accordance with the weight.

26. The method of claim 25, wherein keywords included in the user profile are limited to the N^{th} ranking, N being a natural number.

27. The method of claim 13, further comprising:
receiving a command signal for a web document desired to be displayed from a user; and
displaying the web document according to the inputted command signal.

28. The method of claim 13, further comprising storing the tag information, the mapping table and the user profile.

29. A recorded medium tangibly embodying a program of instructions executable by an apparatus to collect user preference information by using tag information, the recorded medium being readable by the apparatus, the program comprising:
analyzing a hypertext makeup language (HTML) source of a web document outputted to the apparatus and searching at least one tag of an anchor tag, a form tag and a combination thereof which are included in the web document;
extracting tag information from the searched tag;
detecting a keyword from the tag information; and
collecting user preference information including a user profile generated by using the keyword.
